(19) United States
(12) Patent Application Publication
(10) Pub. No.: US 2012/0066223 A1
(43) Pub. Date: Mar. 15, 2012

(54) METHOD AND COMPUTING DEVICE FOR CREATING DISTINCT USER SPACES

(75) Inventors: Philip Schentrup, Hollywood, FL (US); Michael Kelly, Deerfield Beach, FL (US)

(73) Assignee: OPENPEAK INC., Boca Raton, FL (US)

(21) Appl. No.: 12/880,778

(22) Filed: Sep. 13, 2010

(51) Int. Cl. G06F 17/30

(52) U.S. Cl. 707/737; 707/E17.089

(57) ABSTRACT

A method and computing device for creating distinct user spaces are described. Concerning the method, in a platform originally designed as a single user platform, user data associated with a plurality of users can be stored and segmented. In addition, links to point to user data that is associated with a current user can be generated in which the link creation can exploit a predefined path associated with storing data in the single user platform. The method can also include the step of preventing the current user from accessing user data associated with non-active users.

### FIELD OF TECHNOLOGY

The subject matter herein is directed to multi-user accounts in operating systems and more particularly, to multi-user accounts in operating systems with access restrictions.

### BACKGROUND

The Android operating system, developed by Google, Inc. of Mountain View, Calif., is designed to be a single user platform. Android was developed on top of a Linux kernel, which supports multiple users. The Android system, however, effectively disables the multi-user aspect of the Linux kernel by assigning unique user identifications (user ID) to each Android application. In particular, when an Android application reads or writes data, the application can only access the data with its unique user ID. Thus, such an application can only read or modify data that the application itself creates. This feature is necessary to prevent potentially unscrupulous applications from accessing sensitive information generated by other applications. Relying on unique user IDs to isolate applications for security purposes unavoidably strips the ability of Android to create multiple distinct user workspaces.

### SUMMARY

A method of creating distinct user spaces is described herein. The method can include the steps of—in a platform originally designed as a single user platform—storing user data associated with a plurality of users and segmenting the user data associated with the plurality of users. The method can also include the step of creating one or more links to point to user data that is associated with a current user. The link creation can exploit a predefined path associated with storing data in the single user platform. The predefined path may be a partially predefined path. As an example, the links can be symbolic links, and the user data can be made up of application data, cache data or media data. Moreover, creation of the links does not affect an ability to assign unique user identifications to applications that are associated with the platform.

The method can also include the step of preventing the current user from accessing user data associated with non-active users. This access prevention can be accomplished through the use of file system permissions.

As an example, segmenting the user data associated with the plurality of users can be performed by creating separate directories for each of the plurality of users. In addition, the user data associated with the plurality of users can be segmented on one or more data storage elements. As an example, the data storage element can be a common data storage element or a combination of different data storage elements. As another example, the data storage elements can be local data storage elements or remote data storage elements, and the local data storage elements and the remote data storage elements can include volatile data storage elements or non-volatile data storage elements. In another option, the user data associated with the plurality of users on one or more data storage elements can be segmented in accordance with a fixed or dynamic allocation.

The method can also include the steps of selectively encrypting and decrypting the user data. In one embodiment, decrypting the user data comprises decrypting the user data for the current user and moving the decrypted data to a volatile data storage element. The method can also include the step of authenticating the current user prior to providing the current user with access to the user data associated with the current user. For example, authenticating the current user can mean authenticating the current user at a remote element.

Another method for use on a computing device is described herein. This method can include the steps of providing a single user platform on the computing device and creating multiple distinct and independent user spaces that collectively store data associated with a plurality of users. This process can convert the single user platform into a multiple user platform such that each user is assigned one of the independent user spaces. Creating multiple distinct and independent user spaces can include the steps of storing user data associated with the plurality of users, segmenting the user data associated with the plurality of users and creating one or more links to point to user data that is associated with a current user. The link creation can exploit a predefined path associated with storing data in the single user platform. The predefined path can be a partially predefined path. Further, the user data associated with the plurality of users can be segmented on one or more data storage elements. The user data associated with the plurality of users can also be segmented by creating separate directories for each of the plurality of users. Creating the multiple distinct and independent user spaces, however, does not affect an ability to assign unique user identifications in the multiple user platform. The method can further include the step of preventing a current user of the computing device from accessing data associated with non-active users.

A computing device containing a platform originally designed as a single user platform is also described herein. The computing device can include a first data storage element configured to store user data associated with a plurality of users and a processor communicatively coupled to the first data storage element. The processor can be operable to segment the user data associated with the plurality of users on the first data storage element and to create one or more links to point to user data associated with a current user. The link creation by the processor can exploit a predefined path associated with storing data in the single user platform. This predefined path can be a partially predefined path. As an example, the user data can include application data, cache data or media data, and the links can be symbolic links. In addition, the link creation does not affect assignment of unique user identifications in the platform.

The processor is operable to segment the user data associated with the plurality of users by creating separate directories for each of the plurality of users. The computing device can also include a second data storage element that is separate and distinct from the first storage element, and the second data storage element can be configured to store user data associated with at least some of the plurality of users. As an example, the second data storage element can be a portable storage element capable of being selectively removed from the computing device. The processor can be further operable to segment the user data associated with the plurality of users on the first data storage element in accordance with a fixed or dynamic allocation. As an option, the processor can be further operable to prevent the current user from accessing user data associated with non-active users.

The computing device can also be equipped with an encryption engine, which can selectively encrypt and decrypt the user data. The processor can also be used to authenticate the current user.

Another computing device containing a platform originally designed as a single user platform is described herein. This computing device can be configured to cooperate with a network in conducting operations. The device can include a local data storage element that can be configured to store user data associated with a plurality of users and can also include an interface that can be configured to communicate with a remote data storage element that can form part of the network. The remote data storage element can be configured to store user data associated with the plurality of users. The computing device can include a processor in which the processor can be operable to segment the user data associated with the plurality of users on the local data storage element and segment the user data associated with the plurality of users on the remote data storage element. The processor can also be operable to create one or more links to point to user data associated with a current user. The link creation by the processor can exploit a predefined path associated with storing data in the single user platform. The predefined path can be a partially predefined path.

The user data associated with the current user can be stored on the local data storage element, the remote data storage element or both. The processor can be further operable to segment the user data associated with the plurality of users on the local data storage element and the remote data storage element by creating separate directories for each of the plurality of users. The processor can also be operable to prevent the current user from accessing user data associated with non-active users. The user data associated with the non-active users can be stored on the local data storage element, the remote data storage element or both.

### BRIEF DESCRIPTION OF THE DRAWINGS

Embodiments of the present application will now be described, by way of example only, with reference to the attached Figures, wherein:

FIG. 1 illustrates an example of a computing device and associated network;

FIG. 2 illustrates an example of a method for creating multiple independent user spaces; and

FIG. 3 illustrates an example of a representation of a directory structure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

Several definitions that apply throughout this document will now be presented. A “user space” is defined as an environment reserved for a particular user where that user may access various types of data and perform other computing or communication operations. A “platform” is defined as an operating environment composed of hardware and/or software components that serve as interfaces or specifications for interactions within a computing device. A “single user platform” is defined as a platform that is designed to accommodate a single user space and possibly an administrator with default control over the platform. A “multiple user platform” is defined as a platform that is designed to accommodate a more than one user space and possibly an administrator with default control over the platform. The phrase “originally designed as a single user platform” is defined as a platform that is or was intended to be a single user platform but that has or will be altered or modified in some way to accommodate more than one user space. The phrase “collectively store data” is defined as a process in which multiple portions of data are stored across multiple storage elements or across a single storage element.

The term “computing device” is defined as an electronic device configured to conduct various operations that manipulate or process data. A “network” is defined as a collection of two or more components in which the components are permitted to at least exchange signals with one another. The word “data” is defined as all forms of information that are capable of being generated and at least temporarily stored. The word “plurality” means a number that is greater than one. A “processor” is defined as a component or a group of components that execute(s) sets of instructions. An “interface” is defined as a component or a group of components that connect(s) two or more separate systems or elements such that signals can be exchanged between or among them. A “directory” is defined as a digital file system structure that includes files and folders and that organizes the files and folders into a hierarchical organization. The word “link” is defined as an object that specifies the location of another object. A “symbolic link” is defined as a file system construct that contains a reference to another file or directory in the form of an absolute or relative path and that affects pathname resolution.

A “data storage element” is defined as a component or a group of interconnected components that are configured to retain data subject to retrieval. The term “non-volatile data storage element” means a data storage element that is configured to retain data irrespective of whether the data storage element is receiving power. Conversely, the term “volatile data storage element” means a data storage element that requires power during at least some interval to retain data. The term “fixed allocation” is defined as an allocation of memory/storage that is assigned prior to the execution of any programs or operations that may utilize the allocation and stays static during such execution of the programs or operations. In contrast, a “dynamic allocation” is defined as an allocation of memory/storage that may or may not be assigned prior to the execution of any programs or operations that may utilize the allocation and is adjustable prior to, during or following such execution of the programs or operations. The terms “encrypt” or “encrypting” are defined as altering or translating data to restrict access to the data, while the terms “decrypt” or “decrypting” are defined as decoding data that has been encrypted.

As noted earlier, the Android system disables the multi-user aspect of the Linux kernel by assigning unique user IDs to each Android application. The distinctive user IDs are necessary to protect sensitive data that is related to various applications stored on a device. Thus, the necessity of security in such a device minimizes its utility. The description here seeks to counteract this reduced effectiveness of the device without compromising its security.

In particular, a method of creating distinct user spaces in a computing device that does not affect the practice of assigning unique user IDs for applications is described herein. The method can include the steps of—in a platform originally designed as a single user platform—storing user data associated with a plurality of users and segmenting the user data associated with the plurality of users. The method can also include the step of creating links to point to user data that is associated with a current user in which the link creation exploits a predefined path associated with storing data in the single user platform. The current user can also be prevented from accessing user data associated with non-active users, and the link creation does not affect the assignment of unique user IDs to applications in the platform.

Because distinct user spaces can be created without affecting application user IDs, the method can bring additional functionality to a computing device without compromising its security. Thus, consumers who have grown accustomed to multi-user experiences on computing devices can continue to realize such an experience on units powered by certain restrictive operating system environments.

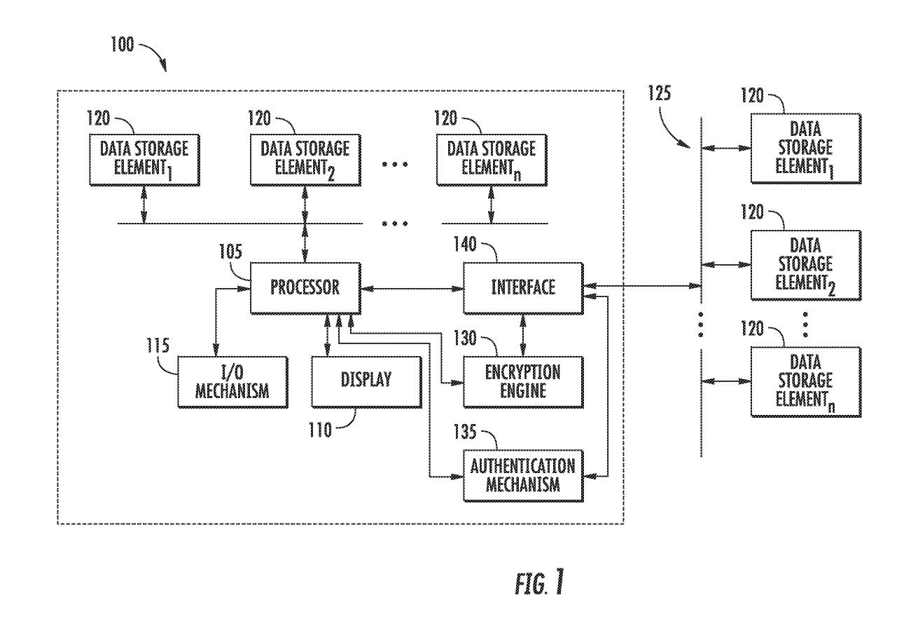

Referring to FIG. 1, a computing device 100 is shown in block diagram form. The computing device 100 can be in the form of virtually any device that is capable of processing data, and suitable examples without limitation include tablets, smart phones, desktop computers, communication devices, laptops and entertainment devices. In addition, the device 100 can be configured to exchange communications (wireless and/or wired) with various elements. For example, the device 100 can be communicatively coupled with one or more components that make up a network or with components that are not part of a network, which includes elements that can be selectively engaged with the device 100, like portable storage devices. Moreover, the communication exchanges between (or among) the device 100 and the other components can be synchronous or asynchronous.

The device 100 can include a processor 105, which can be configured to execute sets of instructions to carry out procedures that are associated with the descriptions recited herein. In one arrangement, the device 100 also has a display 110 and an input/output (I/O) mechanism 115. The display 110 can be, for example, a touch screen display, and as another example, the I/O mechanism 115 can be a keypad or keyboard (not shown) or a pointing device (not shown). Of course, the display 110, if built as a touch screen display, may serve as the I/O mechanism 115. It must be noted, however, that the device 100 is not necessarily limited to these types of user interface elements, as other forms of such components may be implemented into the device 100.

The device 100 can also be equipped with one or more data storage elements 120, which can be used to store various forms of data. The device 100 can have any suitable number of the data storage elements 120 (including just one), and the elements 120 can be volatile or non-volatile. Moreover, the device 100 may be communicatively coupled to a network 125, which can also include one or more data storage elements 120. The device 100 can be configured to cooperate with the network 125 in conducting various operations. As one aspect of this cooperation, the device 100 can be arranged to store data on the data storage elements 120 that are part of the network 125. In addition, the data storage elements 120 that are part of the network 125 may also be volatile or non-volatile storage elements. A data storage element 120 that is integrated within (permanently or temporarily) the computing device 100 is defined as a local data storage element, while one that is removed from the device 100 such that a wired or wireless connection is required to conduct an exchange with that element is defined as a remote data storage element. For example, a data storage element 100 that is selectively coupled to the device 100, like a portable memory device, is a local data storage element. As another example, a data storage element 120 that is part of the network 125 is a remote data storage element. Suitable examples of data storage elements 120 include all or a portion of a hard disk drive, a flash memory device and a portable memory device (such as a universal serial bus (USB) drive). Of course, it is understood that the term data storage element is not meant to be limited in any way by these exemplary listings and is meant to be broad in nature. Also, it must be stressed that use of the term “storage,” “store” or “storing” does not necessarily rule out the utilization of volatile or temporary memory components to store data.

In one arrangement, the computing device 100 can also include an encryption engine 130, which can be used to selectively encrypt and/or decrypt data. Any suitable type and number of encryption and decryption techniques can be employed to ensure secure and efficient retrieval of data. As another option, the device 100 can include an authentication mechanism 135 for authenticating one or more users of the device 100. The authentication mechanism 135 can perform authentications on its own or in conjunction with one or more other elements, as will be described below. To communicate with the network 125 or any other external system or component, the device 100 can contain one or more interfaces 140. If desired, the encryption engine 130 and the authentication mechanism 135 can be directly and communicatively coupled to the interface 140 for exchanging signals with the network 125 or other external elements. In addition, the processor 105 can be communicatively coupled (directly or indirectly) with the display 110, the I/O mechanism 115, the data storage elements 120, the network 125, the encryption engine 130, the authentication mechanism 135 and the interface 140.

In accordance with the description herein, the computing device 100 can be configured to accommodate multiple users. This feature is possible even if the computing device 100 is equipped with a platform that was originally intended for use by a single individual. In particular, each user can operate the device 100 and can generate, store and retrieve data on the device 100. This data can be stored on any number or type of the data storage elements 120, including those that are part of the network 125. In addition, a particular user's data can be protected from unauthorized access by any of the other users of the device 100. All of this can be done with minor affect on the original single user platform of the device 100.

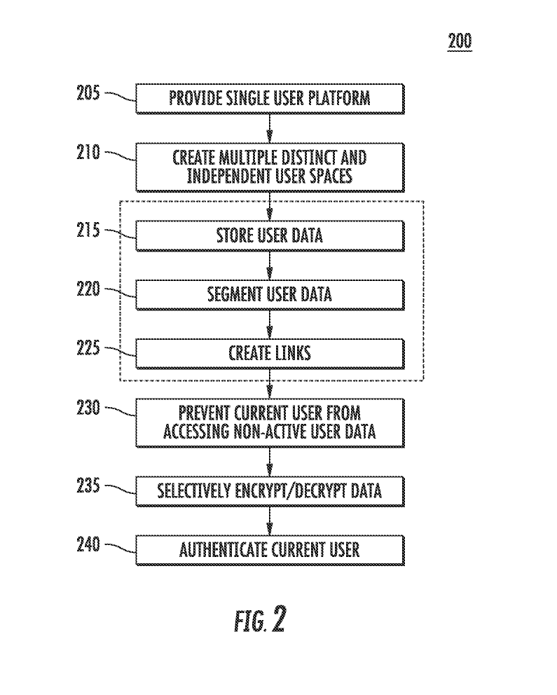

Referring to FIG. 2, a method 200 is shown that presents an exemplary process for creating distinct user spaces in a platform originally designed as a single user platform. When describing the method 200, reference will be made to the elements of FIG. 1, although it is understood that the method 200 can be practiced in any other suitable system or with any other suitable components. Further, the method 200 is not necessarily limited to the chronological order presented in FIG. 2, as these steps can be executed in accordance with any suitable sequence. Also, the method 200 may be adjusted to include other processes or operations not recited here or to remove some of the steps illustrated in FIG. 2.

At step 205, a single user platform can be provided on a computing device, and at step 210, multiple distinct and independent user spaces that collectively store data associated with a plurality of users can be created. A “distinct and independent user space” is defined as a user space that exists with no dependency on another user space and is protected from access by other users, except for possibly an administrator with default control over the created user spaces. This process can convert the single user platform into a multiple user platform such that each user is assigned one of the independent user spaces.

One example of how the multiple user spaces can be generated is illustrated in steps 215, 220 and 225 (the dashed outline around these steps indicates that other suitable techniques may be employed to create the user spaces). At step 215, in the platform originally designed as a single user platform, user data that is associated with a plurality of users can be stored. The user data associated with the plurality of users can be segmented, as shown at step 220. At step 225, one or more links that point to user data that is associated with a current user can be created. This link creation can exploit a predefined path that is associated with storing data in the single user platform.

To help explain these steps, reference will be made to FIG. 1. Initially, the computing device 100 may include a single user platform. The device 100, however, may be altered to create multiple user spaces to allow a plurality of users to use the device 100 without fear of unauthorized access to their data. To accomplish this feature, the single user platform on the device 100 is effectively converted to a multiple user platform.

Each of the plurality of users may have data associated with them stored on one or more data storage elements 120 of the device 100 and/or the network 125. The processor 105 of the device 100 can manage the storage of this data. Consider the example where there are two authorized users for the computing device 100. Both users may generate data associated with their activities on the device 100, and this data may be stored on one or more data storage elements 120. As an example, the data may be stored on a common data storage element 120, which can be a single data storage element 120 with multiple locations to store data. The data associated with these users can be stored at an appropriately divisible location or locations on the common data storage element 120. As another example, the data associated with these users can be stored across a combination of different data storage elements 120. In particular, one user's data can be stored on one data storage element 120, while the other user's data can be stored at a different data storage element 120. Also, the data associated with these two users can be stored together on different data storage elements 120. These data storage elements 120 can be local or remote, like those that form part of the network 125, and can also be volatile or non-volatile. Data associated with these users can also be stored on a portable data storage element 120, such as a USB device or a removable disc. In short, the data associated with a plurality of users can be stored on virtually any type and any number of data storage elements 120.

The type of data the plurality of users may generate can take on many forms. Several exemplary types of data include application data, cache data and media data. The term “application data” is defined as data that is associated with programs designed for direct interaction with an end user. In addition, the term “cache data” is defined as data that is or will be temporarily stored in a storage mechanism. The term “media data” is defined as data that is associated with the presentation of entertainment to a user. The examples presented here, however, are not intended to be limiting. In one particular arrangement, the application data associated with the plurality of users can be stored in one data storage element 120, while the cache data associated with the users can be stored at a different location of the element 120 or on a different data storage element 120. Similarly, the media data associated with the plurality of users can be stored at a different location of the element 120 storing the application and cache data, or the media data can be stored on an element 120 separate from the other element(s) 120 storing the application and cache data.

As previously explained, the user data associated with the plurality of users can be segmented. The phrases “segmenting user data” and “segment user data” are defined as a process of arranging data associated with a plurality of users such that each user has a path to access his/her data. This segmenting process can be conducted over one or more of the data storage elements 120. One particular example as to how the segmenting can be performed includes the process of creating separate directories for each of the plurality of users. For example, the processor 105 of the computing device 100 can create a directory for a first user for the data associated with that first user, while the processor 105 can generate another directory for a second user for the data associated with the second user. Additionally, the processor 105 can produce a directory for each type of data associated with each of the plurality of users.

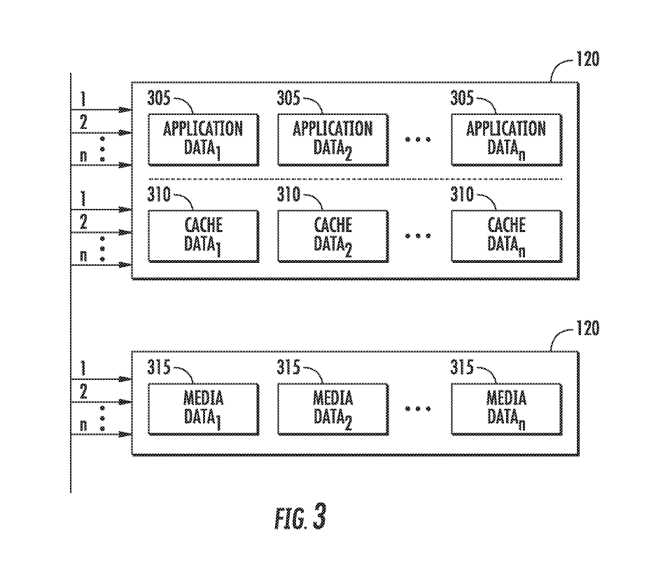

An exemplary representation of this process is shown in FIG. 3. In FIG. 3, two data storage elements 120 are pictured in which the top element 120 stores application data 305 and cache data 310 associated with a plurality of users. The dashed line between the application data 305 and the cache data 310 shows that these data types can be stored in different locations on the element 120. The bottom data storage element 120, which can be a portable data storage element 120, for example, stores media data 315 associated with the plurality of users. As can be seen, the first block of application data 305 is assigned a subscript number of “1” and is associated with a first user of the plurality of users. Likewise, the second block of application data 305 is assigned a subscript number of “2” and is associated with a second user of the plurality of users. Each of the plurality of users of the computing device 100 may have blocks of application data 305 in this data storage element 120, which is represented by the series of dots following the second block of application data 305 and by the last block of application data 305 designated by the subscript “n.” To the left of the data storage elements 120, a series of arrows tied to a bus and pointing to the elements 120 are shown. For example, the top three arrows point to the section of the top data storage element 120 housing the application 305 and are respectively designated with the characters “1,” “2” and “n.” These arrows are associated with the application data 305 by their subscript designations. Thus, these arrows, along with the bus and the application data 305 in the top data storage element 120, represent a directory that is created for each of the plurality of users who have application data 305 in this element 120. This same principle can apply to the cache data 310 in this element 120 and to the media data 315 in the bottom data storage element 120. Thus, as can be seen, directories can be created based on the type of data that is stored, the number of users and the nature and number of data storage elements 120.

Of course, it must be stressed that the example described in FIG. 3 and the related text above is not intended to be limiting. For example, it is not necessary to segregate the data associated with the plurality of users, either on a single data storage element 120 or across multiple data storage elements 120. Moreover, it is not necessarily required to create directories for each of the plurality of users of the computing device 100 or for each of the data types associated with a particular user. Those skilled in the art will appreciate that various combinations consistent with the above description are applicable here.

As also previously noted, links can be created to point to user data that is associated with a current user. A “current user” is defined as a user of the plurality of users who currently has access to the programs and/or features of a computing device. In one arrangement, the processor 105 creates one or more links for the current user that point to the user data associated with the current user. That is, the created links can point to the directories that have been established for the current user. Thus, for example, if the current user has three established directories (one each for application data, cache data and media data, for example), the processor 105 can create three corresponding links to point to these directories. In one arrangement, the links can be symbolic links, and their creation can be dynamic in nature, meaning that the links can be created, for example, once a current user is properly logged in to the computing device 100. This link creation can also exploit a predefined path associated with storing data in the single user platform. The phrase “exploit a predefined path associated with storing data in the single user platform” is defined as the utilization of at least a portion of a preexisting file system path in a single user platform to access data. As an example, the processor 105 can rely on a portion of the original directory structure to point—through the created link—to the relevant data associated with the current user.

For example, consider a single user platform where a current user's data is expected to be in a “/data” directory. If the current user's data is labeled as “userdata,” then the pathname for retrieving such data is “/data/userdata.” This data can refer to any type of data. In a modified platform with, for example, two users, directories can be established for the data associated with these users. For the first user, an exemplary pathname for retrieving the first user's data can be “/datatop/user1/userdata,” while a pathname for retrieving the second user's data can be “/datatop/user2/userdata.” Thus, if the current user is the second user in the modified platform, the processor 105 can create a link when the second user becomes active (e.g., logs in) for “/data” to point to the data associated with the current user (the second user). As an example, the pathname can be as follows: “/data→/datatop/user2/userdata,” where the arrow represents the created link. It must be pointed out that the pathnames recited here and the characters that form them are merely exemplary in nature, as the underlying process described above can apply to virtually any file system and the protocols associated with it.

As such, the process described above can lead to the creation of multiple user spaces by relying on at least a portion of an existing directory structure. In doing so, the original platform is unaware of the remapping of the actual directory structure and behaves as if the original arrangement is intact. This process can be particularly useful if part of the original directory structure, such as the root directory, cannot be modified after the computing device 100 is powered up. Moreover, the creation of the multiple distinct and independent user spaces does not affect an ability of the computing device 100 to assign unique user IDs in the multiple user platform. In particular, applications that are downloaded onto the computing device 100 may continue to be assigned a unique user ID in the modified platform. This assignment of unique user IDs for the applications can occur across all the user spaces for the plurality of users, which can maintain the security that the use of unique user IDs presents.

As an option, the step of segmenting the user data associated with the plurality of users can be in accordance with a fixed or dynamic allocation. In particular, the processor 105 can set fixed amounts of data space for one or more of the plurality of users when the directories are created. This fixed amount of space can apply to one or more of the types of data that are associated with the plurality of users, too. The setting of the fixed amounts can also be based on the type of data storage element 120 that is to be used to store the data. As an alternative, the processor 105 can dynamically allocate space for the data associated with the plurality of users. For example, the processor 105 can allocate more space across one or more of the data storage elements 120 for a user who requires additional storage space, based on current and past usage in comparison to the other users. The dynamic allocation of data can be based on the type of data involved and the type of data storage element 120, similar to the fixed allocation process. It is important to note that the fixed and dynamic allocations are not necessarily exclusive of one another. In particular, a combination of both fixed and dynamic allocations can be employed for a certain user or users and types of data and data storage elements 120.

Referring back to the method 200 of FIG. 2, at step 230, a current user can be prevented from accessing user data associated with non-active users. At step 235, the user data can be selectively encrypted and decrypted. Finally, at step 240, the current user can be authenticated to provide the current user with access to the user data associated with the current user.

For example, referring once again to FIG. 1, in view of the creation of multiple user spaces, the processor 105 can take steps to prevent a current user from accessing user data associated with other users who are not currently logged in. The processor 105 can do so by relying on file system permissions or some other technique that restricts such access.

For additional protection, the processor 105 can direct the encryption engine 130 to selectively encrypt and decrypt user data associated with the plurality of users. For example, the encryption engine 130 can encrypt user data prior to it being stored on any of the data storage elements 120 using any suitable encryption techniques. When the user data is retrieved from the data storage element(s) 120, the encryption engine 130 can decrypt such data. In one arrangement, once the user data is decrypted, the user data is stored in a volatile data storage element 120. This feature can further protect a user's data because the decrypted data will be lost—as opposed to being held in a non-volatile element 120—if the computing device 100 is powered down and someone other than the previous current user logs into the computing device following the shutdown.

To further maintain the integrity of user data, the current user of the computing device 100 can be authenticated prior to providing the current user with access to the user data associated with the current user. Many procedures may be used to authenticate the current user. As an example, the current user can enter a password, which the processor 105 can verify to authenticate the current user. As another example, the computing device 100 can be equipped with software and circuitry to enable the current user to provide a biometric sample or measurement, such as a fingerprint or iris scan or voice sample. The processor 105 can also authenticate the current user based on these samples. In yet another example, the criteria used to verify the identity of the current user can be processed at a remote location, such as by a suitable mechanism in the network 125. Once authenticated by the remote location, the remote location can signal the processor 105, which can then take steps to provide the appropriate level of access for the authenticated user. Although not necessary, each of the plurality of users may be required to be authenticated before being granted access to user data.

It has been previously pointed out that user data can be stored on both local and remote data storage elements 120. For example, user data can be stored on data storage elements 120 that are contained within the computing device 100 in addition to data storage elements 120 of the network 125. All of the previously described features are applicable to remote data storage elements 120. For example, the processor 105 can direct user data to be stored on remote elements 120 and can segment such remotely stored data (in addition to or in lieu of local storage). Further, the processor 105 can generate links that point to the data on the remote elements 120. Arrangements can also be made to have relevant components of the computing device 100 to encrypt/decrypt user data stored remotely. In another embodiment, one or more of these processes can be handled by components that form part of a device that houses the remote data storage elements 120. For example, the network 125 may include one or more components that can perform some or all of the techniques described above in relation to the computing device 100.

Examples have been described above regarding a method and computing device for creating distinct user spaces. Various modifications to and departures from the disclosed embodiments will occur to those having skill in the art. The subject matter that is intended to be within the spirit of this disclosure is set forth in the following claims.

What is claimed is:

1. A method of creating distinct user spaces, comprising:
in a platform originally designed as a single user platform, storing user data associated with a plurality of users;
segmenting the user data associated with the plurality of users; and
creating one or more links to point to user data that is associated with a current user, wherein the link creation exploits a predefined path associated with storing data in the single user platform.

2. The method according to claim 1, further comprising preventing the current user from accessing user data associated with non-active users.

3. The method according to claim 2, wherein preventing the current user from accessing user data comprises preventing the current user from accessing data associated with non-active users through the use of file system permissions.

4. The method according to claim 1, wherein segmenting the user data comprises segmenting the user data associated with the plurality of users by creating separate directories for each of the plurality of users.

5. The method according to claim 1, wherein segmenting the user data comprises segmenting the user data associated with the plurality of users on one or more data storage elements.

6. The method according to claim 5, wherein the data storage element is a common data storage element or a combination of different data storage elements

7. The method according to claim 6, wherein the data storage elements include local data storage elements or remote data storage elements.

8. The method according to claim 7, wherein the local data storage elements and the remote data storage elements include volatile data storage elements or non-volatile data storage elements.

9. The method according to claim 1, wherein segmenting the user data further comprises segmenting the user data associated with the plurality of users on one or more data storage elements in accordance with a fixed or dynamic allocation.

10. The method according to claim 1, wherein the user data includes application data, cache data or media data.

11. The method according to claim 1, wherein the links are symbolic links.

12. The method according to claim 1, further comprising selectively encrypting and decrypting the user data.

13. The method according to claim 12, wherein decrypting the user data comprises decrypting the user data for the current user and moving the decrypted data to a volatile data storage element.

14. The method according to claim 1, further comprising authenticating the current user prior to providing the current user with access to the user data associated with the current user.

15. The method according to claim 14, wherein authenticating the current user comprises authenticating the current user at a remote element.

16. The method according to claim 1, wherein the creation of the links does not affect an ability to assign unique user identifications to applications that are associated with the platform.

17. A method for use on a computing device, comprising:
providing a single user platform on the computing device; and
creating multiple distinct and independent user spaces that collectively store data associated with a plurality of users, thereby converting the single user platform into a multiple user platform such that each user is assigned one of the independent user spaces.

18. The method according to claim 17, wherein creating multiple distinct and independent user spaces comprises:
storing user data associated with the plurality of users;
segmenting the user data associated with the plurality of users; and
creating one or more links to point to user data that is associated with a current user, wherein the link creation exploits a predefined path associated with storing data in the single user platform.

19. The method according to claim 17, further comprising preventing a current user of the computing device from accessing data associated with non-active users.

20. The method according to claim 18, wherein segmenting the user data comprises segmenting the user data associated with the plurality of users on one or more data storage elements.

21. The method according to claim 18, wherein segmenting the user data comprises segmenting the user data associated with the plurality of users by creating separate directories for each of the plurality of users.

22. The method according to claim 17, wherein creating the multiple distinct and independent user spaces does not affect an ability to assign unique user identifications in the multiple user platform.

23. A computing device containing a platform originally designed as a single user platform, comprising:
a first data storage element configured to store user data associated with a plurality of users; and
a processor communicatively coupled to the first data storage element, wherein the processor is operable to:
segment the user data associated with the plurality of users on the first data storage element; and
create one or more links to point to user data associated with a current user;
wherein the link creation by the processor exploits a predefined path associated with storing data in the single user platform.

24. The device according to claim 23, wherein the processor is further operable to prevent the current user from accessing user data associated with non-active users.

25. The device according to claim 23, wherein the processor is further operable to segment the user data associated with the plurality of users by creating separate directories for each of the plurality of users.

26. The device according to claim 23, further comprising a second data storage element that is separate and distinct from the first storage element and wherein the second data storage element is configured to store user data associated with at least some of the plurality of users.

27. The device according to claim 26, wherein the second data storage element is a portable storage element capable of being selectively removed from the computing device.

28. The device according to claim 23, wherein the processor is further operable to segment the user data associated with the plurality of users on the first data storage element in accordance with a fixed or dynamic allocation.

29. The device according to claim 23, wherein the user data includes application data, cache data or media data.

30. The device according to claim 23, wherein the links are symbolic links.

31. The device according to claim 23, further comprising an encryption engine, wherein the encryption engine selectively encrypts and decrypts the user data.

32. The device according to claim 23, wherein the processor is further operable to authenticate the current user.

33. The device according to claim 23, wherein the link creation does not affect assignment of unique user identifications in the platform.

34. A computing device containing a platform originally designed as a single user platform, wherein the computing device is configured to cooperate with a network in conducting operations, comprising:
a local data storage element configured to store user data associated with a plurality of users;
an interface configured to communicate with a remote data storage element that forms part of the network, wherein the remote data storage element is configured to store user data associated with the plurality of users; and
a processor, wherein the processor is operable to:
segment the user data associated with the plurality of users on the local data storage element;
segment the user data associated with the plurality of users on the remote data storage element;
create one or more links to point to user data associated with a current user;
wherein the link creation by the processor exploits a predefined path associated with storing data in the single user platform.

35. The device according to claim 34, wherein user data associated with the current user is stored on the local data storage element, the remote data storage element or both.

36. The device according to claim 34, wherein the processor is further operable to prevent the current user from accessing user data associated with non-active users, wherein the user data associated with the non-active users is stored on the local data storage element, the remote data storage element or both.

37. The device according to claim 34, wherein the processor is further operable to segment the user data associated with the plurality of users on the local data storage element and the remote data storage element by creating separate directories for each of the plurality of users.
